(19) United States
(12) Patent Application Publication
(10) Pub. No.: US 2005/0041699 A1
(43) Pub. Date: Feb. 24, 2005

(54) Wavelength division multiplex optical wavelength converter

(76) Inventors: Ian Hugh White, Cambridge (GB); Richard Vincent Penty, Royston (GB); Adrian Wonfor, Cambridge (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/484,418

(22) PCT Filed: Jul. 17, 2002
(86) PCT No.: PCT/GB02/03285

(51) Int. Cl. H01S 3/10; H01S 3/08

(52) U.S. Cl. 372/20; 372/96

(57) ABSTRACT

A WDM optical wavelength converter for converting modulated radiation at a first WDM wavelength channel (λ₁) to corresponding modulated radiation at another WDM wavelength channel (λ₂) comprises: a semiconductor laser (e.g., a sampled grating distributed Bragg reflector SGDBR device) integrated with a semiconductor optical amplifier (SOA). The converter is characterized in that the laser is wavelength tuneable over at least a plurality of wavelength channels and preferably all wavelength channels.

The present invention relates to a wavelength division multiplex (WDM) optical wavelength converter for converting modulated radiation at a first wavelength to corresponding modulated radiation at a second wavelength.

In optical communication systems, traffic is conveyed by optical radiation that is modulated with the communication traffic. Optical radiation in the context of the present invention is defined as electromagnetic radiation within a free-space wavelength range of 560 nm to 2000 nm, though a free-space wavelength of substantially 1550 nm is a preferred part of this range. In WDM optical communication, the radiation is partitioned into a plurality of discrete wavebands (often termed wavelength channels), each waveband being associated with a corresponding communication channel. The plurality of wavebands is termed the WDM comb or grid. For example a typical WDM system can comprise 32 wavelength channels spaced at wavelength intervals of 0.8 nm; such spacing corresponding to a channel frequency separation of 100 GHz at 1550 nm.

A key requirement identified for future WDM systems is the ability to convert communication traffic carried by one wavelength channel to another wavelength channel of the WDM grid. Such conversion is hereinafter termed wavelength conversion. Wavelength conversion provides system flexibility and enables wavelength channels to be assigned at individual nodes of the communication system rather than globally, enabling conversion to a spare wavelength channel if wavelength contention occurs. Further it allows grooming of channels to maximise spectral efficiency of the system.

One method of wavelength conversion is to convert the modulated optical wavelength carrier back into a corresponding electrical signal and to then use the electrical signal to modulate a continuous wave optical carrier at the required new wavelength channel. Conversion back to an electrical signal, however, places a limit on system performance and consequently all-optical wavelength conversion is preferred.

It has been proposed to exploit the nonlinearities of semiconductor optical amplifiers (SOA) to provide all-optical wavelength conversion, as is reviewed in reference [1]. Three main mechanisms of wavelength conversion have been explored: cross-gain modulation (XGM); four-wave mixing (FWM), and cross-phase modulation (XPM).

Another all-optical wavelength converter that has been proposed comprises a fixed wavelength DFB (distributed feedback) laser that is configured to operate (lase) at a wavelength to which wavelength conversion is required. The modulated radiation to be wavelength converted is injected into the DFB laser waveguide where, through a process of XGM, the c.w. radiation generated by the laser is correspondingly modulated.

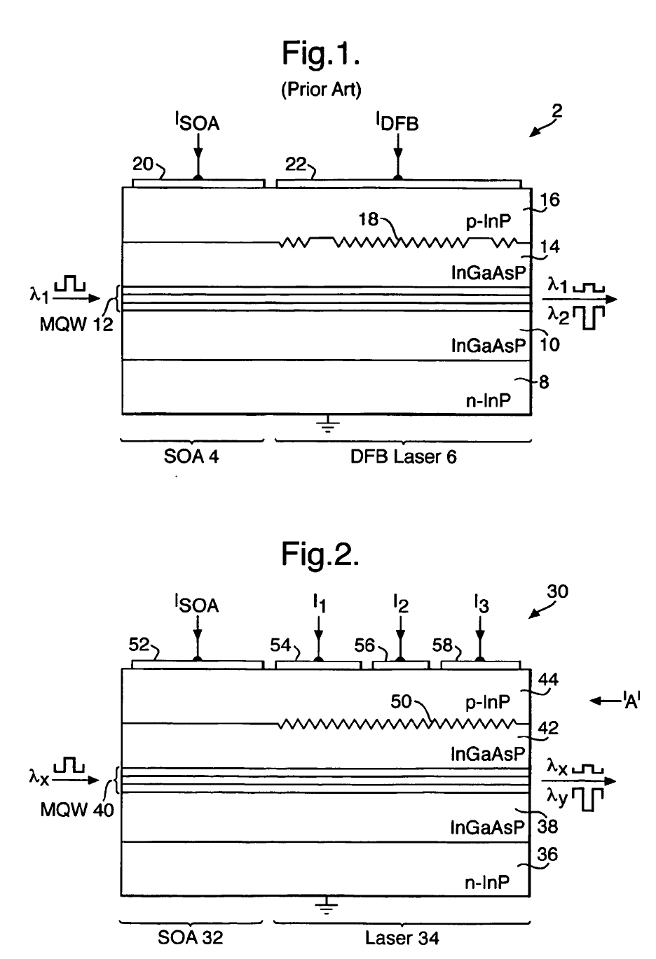

Research into all-optical wavelength converters for operation at 1550 nm has centred on the use of integrated SOA/DFB laser diode devices [2, 3]. FIG. 1 is a schematic representation of such a wavelength converter 2 that comprises an integrated InP/InGaAsP SOA 4 and DFB laser 6 [2]. The wavelength converter 2 comprises a layered structure fabricated on an n-doped InP substrate 8. The layers comprise, in order, an undoped InGaAsP layer 10, MQW (multiple quantum well) layers 12, a further undoped InGaAsP layer 14 and a p-doped InP layer 16. The layers 10 to 14 constitute the optical waveguiding/optical generation layer. Within the undoped InGaAsP layer 14 there is defined a Bragg grating 18. To ensure a single longitudinal mode of operation (i.e. a single wavelength of operation) the grating contain two phase shifts of π/4 (i.e. λ/8) situated at approximately one third and two thirds along its length Respective electrodes 20, 22 are provided on the layer 16 overlying the SOA 4 and DFB laser 6 regions to which respective control currents I_{SOA} and I_{DFB} are applied.

In operation modulated radiation at a first wavelength λ₁ is injected into the layers 10 to 14 of the SOA through an end facet of the device. The SOA 4 amplifies the modulated radiation as it propagates through the device. The DFB laser 6 is configured to lase at a fixed wavelength λ₂. The amplified modulated radiation then propagates into the DFB laser where it then modulates the radiation generated by the laser primarily by a process of cross-gain modulation (XGM). The XGM mechanism (gain saturation conversion mechanism) leads to a logically inverted output in the laser mode and the converter thus outputs, through an end facet, modulated radiation of wavelength λ₁ and corresponding logically inverted modulated radiation (wavelength converted) of wavelength λ₂.

A benefit of injecting the modulated radiation into the SOA is that this reduces the input power of the radiation required to achieve gain saturation within the laser.

An advantage of an integrated SOA and DFB laser is that it reduces system complexity as the source of radiation for providing wavelength conversion is inherent to the device. With an integrated SOA and DFB laser, wavelength conversion (from λ₁=1559 nm to λ₂=1553.5 nm) for NRZ (non-return to zero) data rates up to 10 Gb/s have been demonstrated [2]. Subsequently such a wavelength converter has been demonstrated to be capable of wavelength conversion at data rates up to 40 Gb/s by injecting the input radiation for wavelength conversion into the DFB laser rather than the SOA [3].

Whilst the foregoing wavelength converters, i.e. SOA and integrated SOA/DFB laser devices, have been demonstrated as providing adequate wavelength conversion each has the same limitation that they can only provide wavelength conversion to a fixed wavelength. To date, the published wavelength conversion implementations are of an “any input wavelength” to “fixed output wavelength” type. Whilst this is acceptable for certain applications, there are several contemplated applications where it would be desirable, or necessary, to be able to tune the output wavelength. Such applications include, for example, re-configurable optical crossconnects in which a tuneable wavelength converter could be used for grooming WDM wavelength channels and to avoid wavelength contention, and in optical routers, in which tuneable wavelength conversion could be used to selectively route wavelength channels on the basis of their wavelength.

The present invention has arisen in an endeavour to provide an optical wavelength converter that, at least in part, overcomes the limitations of the known devices.

According to the present invention there is provided a WDM optical wavelength converter for converting modulated radiation at a first WDM wavelength channel to corresponding modulated radiation at another WDM wavelength channel comprising: a semiconductor laser integrated with a semiconductor optical amplifier the converter being characterised in that the laser is wavelength tuneable over at least a plurality of wavelength channels.

Advantageously the laser is wavelength tuneable over all of the wavelength channels of the WDM grid.

In one arrangement the optical amplifier is operable to receive the modulated radiation for wavelength conversion. Alternatively the laser is operable to receive the modulated radiation for wavelength conversion.

Advantageously, in the case of the former, the wavelength converter further comprises a further integrated semiconductor optical amplifier.

In one arrangement the laser is a distributed feedback (DFB) laser that is wavelength tuneable. Preferably the DFB laser has an active region that is divided into a plurality of sections, the sections being tuneable independently of one another to provide the required wavelength tuning.

Alternatively the laser is a distributed Bragg reflector (DBR) laser. Most preferably the DBR laser is a four-section device comprising first reflector, phase, gain and second reflector sections. The reflector sections each preferably comprise a sampled Bragg grating. Alternatively they can each comprise a superstructure Bragg grating.

Wavelength tuning of the laser can be through voltage biasing the laser using an effect such as Quantum Confined Stark Effect (QCSE) or the Franz Keldysh effect. Alternatively it can by electrical current injection. Fine-tuning of the laser to a WDM wavelength channel can be achieved by altering the temperature of the laser.

In order that the invention can be better understood optical wavelength converters in accordance with the invention will now be described, by way of example only, with reference to the accompanying drawings in which:

FIG. 1 is a schematic representation of a known optical wavelength converter [2] as discussed above;

FIG. 2 is a schematic representation of an optical wavelength converter in accordance with a first embodiment of the invention;

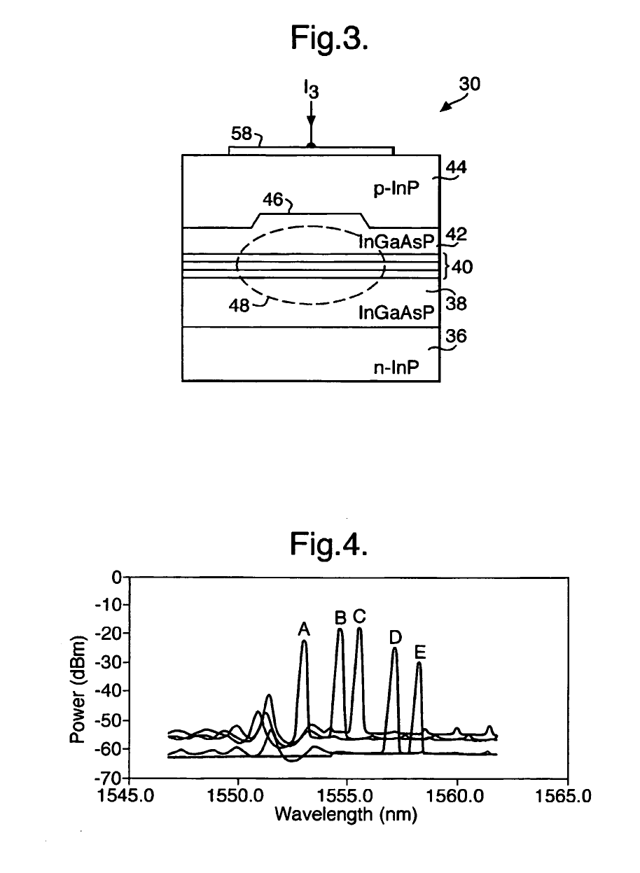

FIG. 3 an end view of the converter of FIG. 2 in a direction “A”;

FIG. 4 illustrate characteristics of the embodiment shown in FIG. 2;

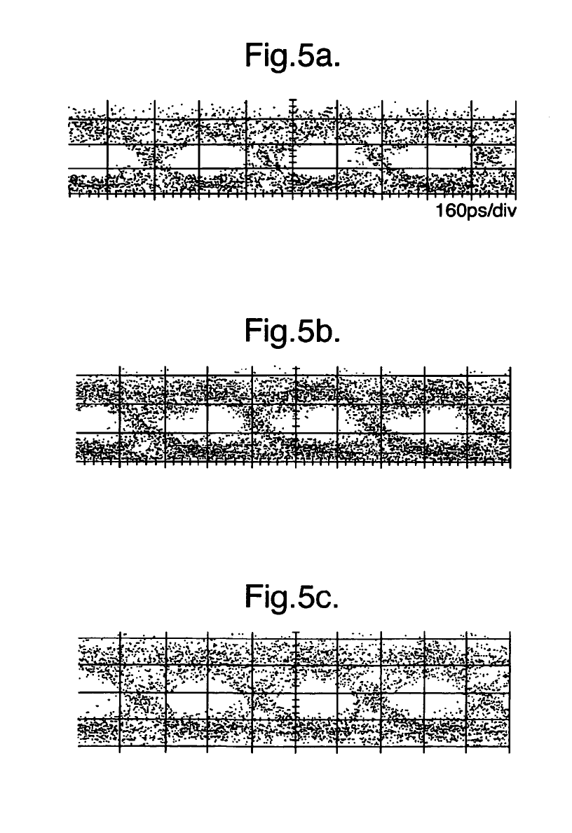

FIG. 5a to 5c are measured “eye” diagrams for the converter of FIG. 2; and

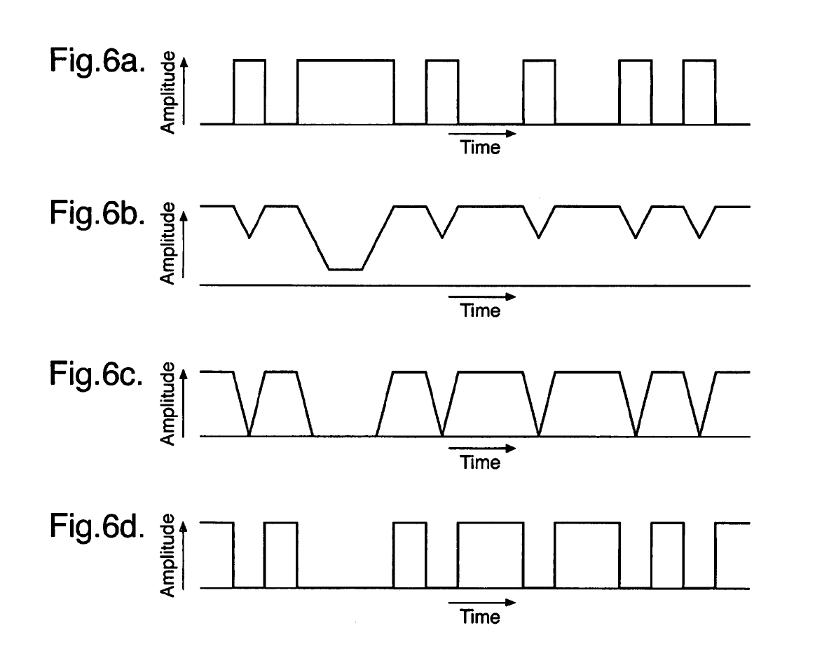

FIGS. 6a to 6d are schematic representations of signals at various locations within the converter of FIG. 2 and respectively illustrate (a) an input signal prior to wavelength conversion, (b) a wavelength converted signal, (c) the wavelength converted signal after it has passed halfway through an SOA, and (d) the wavelength converted signal output from the converter, and

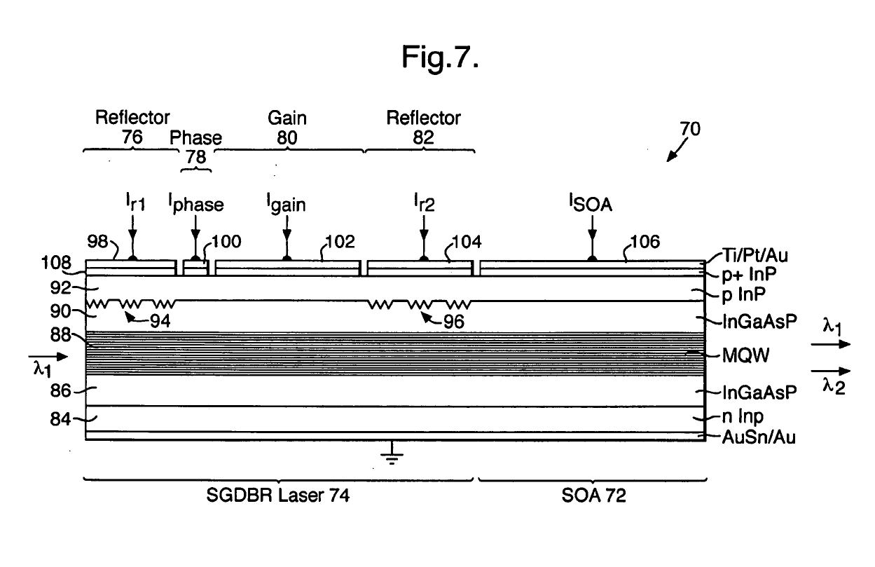

FIG. 7 is a schematic representation of an optical wavelength converter in accordance with a second embodiment of the present invention

Referring to FIGS. 2 and 3 there is shown schematic representations of an optical wavelength converter 30 in accordance with the present invention. FIG. 3 represents an end view of the converter of FIG. 2 in a direction “A”.

The converter 30 comprises a Semiconductor Optical Amplifier (SOA) section 32, and a semiconductor laser section 34. The SOA 32 and DFB laser 34 are fabricated as an integrated device on an n-doped InP substrate 36.

The converter 30 is fabricated as a layered structure on the substrate 36. The layers comprise, in order, an undoped InGaAsP layer 38, MQW (multiple quantum well) layers 40, a further undoped InGaAsP layer 42 and a p-doped InP layer 44. The layers 38 to 42 constitute the optical waveguiding/optical generation layer of the converter. The undoped InGaAsP layer 42 is configured as a ridge structure 46 (FIG. 3) to provide lateral confinement of radiation within the layers 38 to 42, as indicated by dashed line 48 in FIG. 3. It will be appreciated that the layers 38 to 42 thus constitute an optical waveguide that is common to the SOA 32 and laser 34 and which runs in a direction left to right as shown in FIG. 2. Within an upper surface of the ridge 46 there is defined, during fabrication, a Bragg grating 50 that extends over the length of the laser section 34 (FIG. 2). To ensure a high side mode suppression ratio the Bragg grating includes a plurality of phase shifts spaced along its length (not shown).

An electrode 52 is provided on the layer 44 that overlies the SOA section 32 to which a respective control or bias current ISOA is applied.

In contrast to the known wavelength converter, described above (FIG. 1), the electrode used for driving the laser section 34 is divided into three discrete electrodes 50, 52, 54 to which a respective control (bias) current I₁, I₂, I₃ is applied. For ease of fabrication the electrodes can be defined by selectively etching through the conducting electrode layer and an underlying contact layer (not shown) that is used for bonding the former to the p-doped PnP layer 44. Such an arrangement of contacts enables different current densities to be injected into respective operating regions of the laser section 34 and thereby enables the wavelength of operation of the laser to be tuned. In the embodiment illustrated in FIG. 2 the SOA 32 and the three regions 54, 56, 58 of the laser are of length 500, 300, 200 and 300 μm respectively.

By applying different currents to each of the operational regions of the laser the output from the laser can be wavelength tuned discontinuously. This means that the wavelength to which the modulated input radiation is converted can be selected by application of appropriate control currents to the electrodes 54, 56, 58.

For certain bias current conditions the output wavelength can be highly unstable (sometimes giving rise to the generation of two distinct single longitudinal modes) which vary with time. However, other bias conditions provide stable outputs. FIG. 4 shows five spectra, denoted A to E, (i.e. plots of measured output power (dBm) versus wavelength) for the wavelength converter 30 for five sets of bias currents.

As is apparent from FIG. 4 a wavelength tuning span of around 6 nm was achieved with an SMSR (side mode suppression ratio) that is always in excess of 30 dB, but typically >40 dB. Such a wavelength span represents tuning range of over seven WDM wavelength channels having a spacing of 0.8 nm. The wavelength span can be extended slightly in each wavelength direction depending on an acceptable spectral quality and peak power level. The laser bias currents I₁, I₂, I₃ used to obtain the FIG. 4 spectra were:

| | Laser Bias Current (mA) | | |
|---|---|---|---|
| Spectrum | I₁ | I₂ | I₃ |
| A | 46 | 50 | 89 |
| B | 120 | 160 | 120 |
| C | 164 | 120 | 140 |
| D | 47 | 253 | 95 |
| E | 47 | 295 | 42 |

Operation of the wavelength converter will now be described. Modulated radiation at a first wavelength λₓ is injected into the SOA 32 through an end facet of the converter. The SOA 32 amplifies the modulated radiation as it propagates through the SOA section. The tuneable laser section 34 is tuned to lase at a wavelength λ_{y} corresponding to the required converted wavelength. The amplified modulated radiation, λₓ, propagates into the laser 34 where it then modulates the radiation λ_{y} generated by the laser by a process of cross-gain modulation (XGM). The wavelength converter outputs, through an end facet, modulated radiation at the wavelength λₓ and corresponding logically inverted modulated radiation (wavelength converted) at the wavelength λ_{y}.

Optical wavelength conversion using the wavelength converter of the present invention has been experimentally demonstrated. FIG. 5 illustrates measured “eye” diagrams for modulated input radiation of wavelength 1547 nm (FIG. 5a) and output modulated radiation after wavelength conversion to 1558 nm (FIG. 5b) and to 1553 nm (FIG. 5c). The “eye” diagrams are for optical radiation that has been modulated using PRBS (pseudo random binary sequence) at a data rate of 2.488 Gb/s and which has been transmitted over 50 km of standard (17 ps/nm/km) single mode optical fibre

It can be seen from the “eye” diagrams that there is no significant degradation between the input and wavelength converted signals.

The output wavelength of the converter can be fine tuned by adjusting the temperature of the converter. Tuning of around 0.1 nm per ° C. is possible using this technique up to a maximum of 1 to 2 nm. Such fine-tuning enables precise tuning of the device to a selected WDM wavelength channel.

An alternative, and preferred mode, of operating the wavelength converter of the present invention is to inject the modulated radiation for wavelength conversion into the laser section rather than the SOA. In such an arrangement an additional non-linear interaction between the co-propagating input radiation and the wavelength-converted radiation occurs in the SOA as each competes for optical gain of the SOA. The wavelength conversion mechanism for such a mode of operation is represented in FIG. 6a to 6d, which respectively illustrate: 6a an input signal at wavelength λ₁ prior to wavelength conversion, 6b a corresponding wavelength converted signal of wavelength λ₂ output from the laser before it enters the SOA, 6c the wavelength converted signal after passing halfway through the SOA and 6d the wavelength converted signal output from the converter (i.e. having passed through the SOA). As can be seen from FIG. 6b the process of cross-gain modulation (XGM) within the laser, between the input signal (FIG. 6a) at λ₁ and the c.w. signal at λ₂ generated by the laser, produces an inverted version of the input signal, which is of both limited bandwidth and extinction ratio. Passing this wavelength converted signal (FIG. 6b) through the SOA in the presence of the original input signal (FIG. 6a), with the SOA electrically biased strongly into saturation, enables the fast dynamic processes in the saturated SOA to increase the bandwidth and extinction ratio of the converted signal (FIGS. 6c and 6d). In particular gain competition with the co-propagating input signal sharpens both the rising and falling edges of the converted pulses (logic “Is”) whilst the presence of the inverted λ₁ signal causes depleted gain for the gaps between pulses thereby increasing the extinction ratio of the converted signal. It is found that this non-linear interaction, and the corresponding reduced transition times and improved extinction ratios, enables wavelength conversion at faster rates of up to 40 Gb/s. It will be appreciated that in such an arrangement the power of the input radiation will need to be of increased magnitude for efficient wavelength conversion. This can be achieved by, for example, optically amplifying the input radiation prior to wavelength conversion using an optical amplifier external to the converter or alternatively integrating a second SOA into the converter such that it has an SOA at both its input and output.

Referring to FIG. 7 there is shown an optical wavelength converter 70 in accordance with a second, preferred, embodiment of the invention that is intended for operation in a c-band (1530-1560 nm) WDM optical communications network having eighty wavelength channels λ₁ to λ₈₀ with a wavelength spacing of 0.4 nm (50 GHz) and a data rate of 2.5 or 10 Gb/s. The converter 70 is capable of wavelength selectable conversion from any one of the wavelength channels λ₁ to λ₈₀ to any other wavelength channel.

The converter 70 comprises a Semiconductor Optical Amplifier (SOA) 72 integrated with a four-section Sampled Grating Distributed Bragg Reflector (SGDBR) laser 74. The four laser sections comprise: a first sampled grating reflector 76, a phase section 78, a gain section 80 and a second sampled grating section 82. The SOA 72 and laser 74 are fabricated as an integrated layered structure on an n-doped InP substrate 84.

The layers comprise, in order, an undoped InGaAsP layer 86, a MQW (multiple quantum well) layer 88, a further undoped InGaAsP layer 90 and a p-doped InP layer 92. The layers 86 to 90 constitute the optical waveguiding optical generation layers of the converter. The undoped InGaAsP layer 90 is configured as a ridge structure to provide lateral (i.e. into the plane of the paper as illustrated in FIG. 7) confinement of radiation within the layers 86 to 90 such the latter constitute an optical waveguide that is common to the SOA 72 and laser 74 and which runs in a direction left to right as shown in FIG. 7.

The MQW layer 88 comprises eight compressive InGaAsP wells and eight tensile InGaAsP wells with InGaAsP barriers there between. In a known manner the quantum wells are configured to be in a state of tensile or compressive stress by appropriate selection of the material properties. It is important to have both types of wells to ensure the wavelength converter will operate with input radiation that is horizontally or vertically polarised, thus ensuring the device is input radiation polarisation independent.

Within an upper surface of the ridge there is defined, during fabrication, respective Sampled Bragg gratings 94, 96 within the first 76 and second 82 reflector sections of the laser. The gratings 94, 96 are preferably of the form as disclosed in UK patent GB2337135, which is hereby incorporated by way of reference thereto. As described in OB2337135 such gratings comprises a Bragg grating (i.e. constant period) having π/2 discontinuities at selected positions along its length. Such a grating structure has a reflection characteristic comprising a plurality of equally wavelength spaced reflection peaks, or comb of reflection maxima. The spacing of the reflection peaks of the two reflectors 76, 78 are configured to be different such that only a single reflection peak of each reflector can be aligned at any time, such alignment corresponding to the lasing wavelength. As is disclosed in U.S. Pat. No. 4,896,325, wavelength tuning is achieved by displacing one wavelength comb relative to another, by the injection of an electrical current into one or both gratings, such that a new set of peaks align in a manner analogous to a vernier.

Ti/Pt/Au alloy electrodes 98, 100, 102, 104, 106 are deposited on the layer 92 respectively overlying the first reflector section 76, phase section 78, gain section 80, second reflector section 82 and SOA 72. The electrodes 98 to 106 are bonded to the InP layer 92 by a p⁺-doped InP capping layer 108. Respective control currents I_{RI}, I_{PHASE}, I_{GAIN}, I_{R2} and I_{SOA} are applied to the electrodes 98 to 106 for operating the wavelength converter.

As with the wavelength converter 30 described above, the input radiation to be wavelength converted can be injected into the laser section or the SOA, though the former is preferred. Since control operation of four-section DBR laser is well documented this will not be described further.

It will be appreciated that variations can be made to the specific embodiments described without departing from the scope of the invention. For example other forms of tuneable laser can be utilised provided they offer the required wavelength tuning over a number, and preferably all, of the wavelength channels of the WDM optical communication system in which the converter is to operate. Such lasers include for example a superstructure grating distributed Bragg reflector laser.

Furthermore, in the foregoing description the number of quantum wells within the SOA and laser are the same to enable the device to be readily fabricated. In alternative arrangements the quantum well structures can be optimised for each section of the device. In any event it has been found that between 8 and 20 quantum wells are preferred for optimum performance.

### REFERENCES

[1] D Nesset, T Kelly, D Marcenac (1998) “All-Optical Wavelength Conversion Using SOA Nonlinearites” IEEE Comms. Mag. December 1998.
[2] MFC Stephens, RV Penty, I H White, M J Fice, R A Saunders, J E A Whiteaway (1998) “Low Input Power Wavelength Conversion at 10 Gb/s Using an Integrated Amplifier/DFB Laser and Subsequent Transmission Over 375 km of Fibre” IEEE Photon. Tech. Lett., Vol. 10, pp.878-880.
M F C Stephens, D Nesset, K A Williams, A E Kelly, R V Penty, I H White, and M J Fice (1999) “Wavelength conversion at 40 Gbitls via cross-gain modulation in distributed feedback laser integrated with semiconductor optical amplifier” Electron. Lett., Vol.35, No.20, pp.1762-1764.

1-14. (Canceled)

15. A wavelength division multiplex (WDM) optical wavelength converter for converting modulated radiation at a first WDM wavelength channel to corresponding modulated radiation at another WDM wavelength channel, comprising: a semiconductor laser integrated with a semiconductor optical amplifier, the laser being wavelength tuneable over at least a plurality of wavelength channels.

16. The wavelength converter as claimed in claim 15, in which the laser is wavelength tuneable over all of wavelength channels of a WDM grid.

17. The wavelength converter as claimed in claim 15, in which the optical amplifier is operable to receive the modulated radiation for wavelength conversion.

18. The wavelength converter as claimed in claim 15, in which the laser is operable to receive the modulated radiation for wavelength conversion.

19. The wavelength converter as claimed in claim 15, and further comprising a further integrated semiconductor optical amplifier.

20. The wavelength converter as claimed in claim 15, in which the laser is a distributed feedback (DFB) laser.

21. The wavelength converter as claimed in claim 20, in which the DFB laser has an active region that is divided into a plurality of sections, the sections being tuneable independently of one another.

22. The wavelength converter as claimed in claim 15, in which the laser is a distributed Bragg reflector (DBR) laser.

23. The wavelength converter as claimed in claim 22, in which the DBR laser has a first reflector section, a phase section, a gain section, and a second reflector section.

24. The wavelength converter as claimed in claim 23, in which each reflector section comprises a sampled Bragg grating.

25. The wavelength converter as claimed in claim 15, in which the laser is a superstructure-grating distributed Bragg reflector laser.

26. The wavelength converter as claimed in claim 15, in which the laser has a tuning mechanism based on voltage biasing using a quantum confined stark effect (QCSE).

27. The wavelength converter as claimed in claim 15, in which the laser has a tuning mechanism based on voltage biasing using a Franz Keldysh effect.

28. The wavelength converter as claimed in claim 15, in which the laser has a tuning mechanism based on electrical current injection.

29. The wavelength converter as claimed in claim 15, and further comprising means for fine-tuning the laser by altering a temperature of the laser.
